(19) United States
(12) Patent Application Publication
(10) Pub. No.: US 2016/0042183 A1
(43) Pub. Date: Feb. 11, 2016

(54) GENERATING IDENTIFIER

(71) Applicant: IRDETO B.V., Hoofddorp (NL)

(72) Inventors: Calin Ciordas, Hoofddorp (NL); Fan Zhang, Beijing (CN)

(21) Appl. No.: 14/778,844

(22) PCT Filed: Mar. 28, 2013
(86) PCT No.: PCT/CN2013/073393

§ 371 Date: Sep. 21, 2015

(51) Int. Cl. G06F 21/60; G06F 21/73; H03M 13/15

(52) U.S. Cl. CPC G06F 21/60; H03M 13/1515; G06F 21/73

(57) ABSTRACT

There are described methods and apparatus for generating an identifier of a computer device, which may also be an identifier of a software application installed on the computer device such as a web browser. Parameters of the computer device are collected, extended with dummy values, and reordered, to form a permuted extended set of parameters, which in turn is used to generate the identifier.

### FIELD OF THE INVENTION

The invention relates to methods and apparatus for generating an identifier of a computer device, for example using parameters related to and/or received from a software application such as a web browser installed on the computer device.

### BACKGROUND OF THE INVENTION

Patent publications WO2012/122621 and WO2012/122674 describe mechanisms to construct a unique identifier from a fixed number of parameters which may change over a period of time, for use in computing environments. The identifier may be constructed using identifiers of assets such as a motherboard, BIOS, MAC address and hard disk, some of which may change from time to time. Such changes in the parameters can be countered using error correction capabilities, so that the change of small fraction of the contributing parameters leads to the calculated identifier remaining the same. These error correction capabilities can beneficially be added to process of calculating the identifier without revealing the original or ‘correct’ values of the parameters which have subsequently changed.

FIG. 1 illustrates a conversion of a parameter set P consisting of n parameters (p₁, p₂, . . . , pₙ) into an identifying message X consisting of k symbols (x₁, x₂, . . . , xₖ) as described in WO2012/122674. The figure shows the operations that take place in the computer system to recover the identifying message X from the parameter set P and the fingerprint identifier T. The computer system first obtains the n parameters pᵢ in the Read Asset Parameter operations 10. These parameters are converted into hash values hᵢ using a hash functions Hashᵢ 12 that may depend on the specific characteristics of each parameter. Lookup functions L map the hash values hᵢ to received code symbols rᵢ using transform parameters tᵢ that are obtained from the fingerprint function 14 T=(t₁, t₂, . . . , tₙ). The error correction module 16 converts the received symbols into the identifying message X according to a selected error correcting code. The lookup function L and a transform parameter tᵢ are configured to map the initial value of a hash parameter hᵢ to the initial value of the received symbol rᵢ and map all other values for hᵢ to a value that is not equal to the initial value of rᵢ.

WO2012/122674 also describes a variant in which two or more asset parameters are combined using a pre-processing operation to produce an output that is then processed as if a single asset parameter in the process of FIG. 1.

The schemes described in WO2012/122674 are examples of more general technologies in which a fixed number of parameters are converted into an identifying message X, wherein the conversion to X is robust to limited changes in the parameters. This is illustrated in FIG. 2 in which a robust identity determination module 20 covers both the pre-processing functions on the asset parameters, the hash functions, the look-up functions, the transform parameter vector and the error correction procedures of FIG. 1, or other aspects depending on the particular robust identity determination scheme.

The article “How Unique Is Your Web Browser?” by Peter Eckersley of the Electronic Frontier Foundation, which was presented at the Proceedings of Privacy Enhancing Technologies Symposium 2010, describes the results of an experiment collecting detectable properties of web browsers over a large population of browsers. It shows that there are an extremely large number of browser properties that can be used to identify a particular computer, smart phone, tablet or even an end user. Similar browser properties are reported elsewhere, and the HTML5 W3C specification is expected to feature additional API's that may expose further client specific browser properties. Typically, a “fingerprint” JavaScript on a web page may be used to cause a web browser to collect browser specific parameters. This is described in the above Peter Eckersley publication but also in US2011/099480 in which a web server uses collected browser parameters to identify a computer.

Collected browser parameters can be used as a fingerprint in a variety of fraud prevention applications, for example as discussed in US2011/099480. However, storing web browser parameters for the purposes of future identification of a computer device may be undesirable because of the storage requirements and privacy concerns, but prior art techniques that robustly derive a compact identifier from a set of parameters are not generally suited for the processing of web browser parameters. The large number of different possible web browser parameters, the small fraction of actually present parameters in any particular web browser and the typically frequent changes in the presence and values of these parameters over time are problematic for robust identity determination schemes such as those mentioned above. Similar issues arise in respect of other types of software application installed on a computer device, and indeed in respect of a computer device itself.

The invention address these and other problems and limitations of the related prior art.

### SUMMARY OF THE INVENTION

The invention can be used to convert a sparse and dynamically changing parameter set into a fixed number of parameters that can be input to a robust identity determination module to generate an identifier from the parameter set. In particular, the invention can be used to collect parameters related to an installed web browser or other software application, or computer device, and to process the collected parameters to generate an identifier of the software application or computer device which is more robust to changes in the collected parameters, for example by remaining constant under typical limited changes to the parameters.

One application of the invention is to link a web app to a specific web browser instance. As each installed instance of a web browser is usually unique or nearly so, the invention can be used to achieve such a link. The invention also improves protection of information such as the browser parameters, which there may be an interest in keeping confidential, including by providing an identifier from which it is very difficult to retrieve information about the collected browser parameters from which is it generated.

Accordingly the invention provides a method of generating an identifier of a computer device, for example of an instance of a piece of software, for example a piece of software such as a browser or web browser which is installed on the computer device, comprising: collecting a plurality of parameters of the installed computer device, for example by providing to the computer device a script or other code for execution; forming a permuted extended set of parameters comprising applying a permutation to the collected parameters in combination with a plurality of dummy parameters; and determining an identifier of the computer device from the permuted extended set of parameters.

The computer device could be, for example, a smart phone, a tablet computer, a desktop or laptop computer and so forth. The step of collecting may a step of collecting parameters related to a software application installed on the computer device, and the generated identifier of the computer device is also then an identifier of the software application, which may be a web browser.

Typically, the method is repeated a number of times using the same permutation, to determine to determine the identifier of the computer device at each of the plurality of different times. These repeated versions of the identifier can then be compared to check for changes in the identity of the computer device, which maybe indicated by a change in the identifier.

Typically, as the configuration of the computer device changes over time, the parameters which are available for collection from the computer device will change, irrespective of the values of those parameters, and values of the parameters will also change.

Preferably, the permuted extended parameter set is formed of the same number of parameters at each of the plurality of times, by varying the number of added dummy parameters to compensate for changes in the number of collected parameters. Preferably, the number of dummy parameters is at least as many as the number of collected parameters.

The collected parameters may be compressed and processed in various ways for inclusion in the permuted extended parameter set, and the collected parameters may also be reordered or conformed to a particular ordering scheme (for example alphabetical for strings) for inclusion in the permuted extended parameter set, so that the order of collected parameters in the permuted extended set is unchanged between each of the plurality of times.

The permuted extended parameter set may be transformed or cast into the form of an error correcting code, such as a Reed Solomon code. The identifier may then be generated by decoding the error correcting code.

The invention also provides apparatus, for example: a collection function or module arranged collect a plurality of parameters of or relating to a computer device or software application such as a web browser installed on the computer device; a mapping function or module arranged to form a permuted extended set of parameters comprising applying a permutation to the collected parameters in combination with a plurality of dummy parameters; and a determination function or module arranged to determine an identifier of the computer device or installed software application from the permuted extended set of parameters.

The collection function, mapping function and determination function may be installed together on the computer device, or may be installed in part or in whole elsewhere for example on a remote server. The collection function, mapping function and determination function may for example be implemented as a web app for execution by an installed web browser for which an identifier is generated.

The apparatus may therefore comprise a web app or other computer program comprising the above elements, the web app or other computer program being provided on one or more computer readable media, being distributed by a data network, or being provided by a web server to the computer device. A system may include the computer device and any other component or network element providing parts of the apparatus.

The apparatus may further comprise a compression function arranged such that one or more of the collected parameters in the permuted set of parameters are compressed and/or combined, for example using one or more hash functions. The apparatus may also comprise an ordering function arranged such that the order of collected parameters in the permuted extended set is ordered according to a predetermined ordering scheme which does not vary between times at which the browser identifier is re-determined.

The apparatus may also comprise a comparison function arranged to compare identifiers determined by the determination function based on parameters collected from the computer device at a plurality of different times, and to confirm therefrom that the identity of the installed computer device is unchanged between the different times. The determination function may determine the same identifier of the installed computer device even if the set of parameters of the plurality of collected parameters changes, irrespective of the values of those parameters, or of at least one parameter value changes.

The combined number of collected parameters and dummy parameters used to form the permuted extended set is preferably the same at each of the plurality of different times, for example by extending the collected (and optionally compressed and ordered) parameters by a variable number of dummy parameters.

Embodiments of the invention may be used in node-locking or anchoring to bind a software license to a particular end user so as to ensure that the software is only used by an authorised and paid customer. In particular, the invention can be used for node-locking or anchoring software, such as web applications, to a particular browser.

### BRIEF DESCRIPTION OF THE DRAWINGS

Embodiments of the invention will now be described, by way of example only, with reference to the accompanying drawings of which:

FIGS. 1 and 2 illustrate some methods of robust determination of an identifier as described in the prior art;

FIG. 3 illustrates an embodiment of the invention using a web app and applied to a web browser installed on a computer device;

FIG. 4 shows schematically processing of parameters to form an identifier according to embodiments of the invention; and

FIG. 5 is a flow diagram showing steps of an embodiment of the invention.

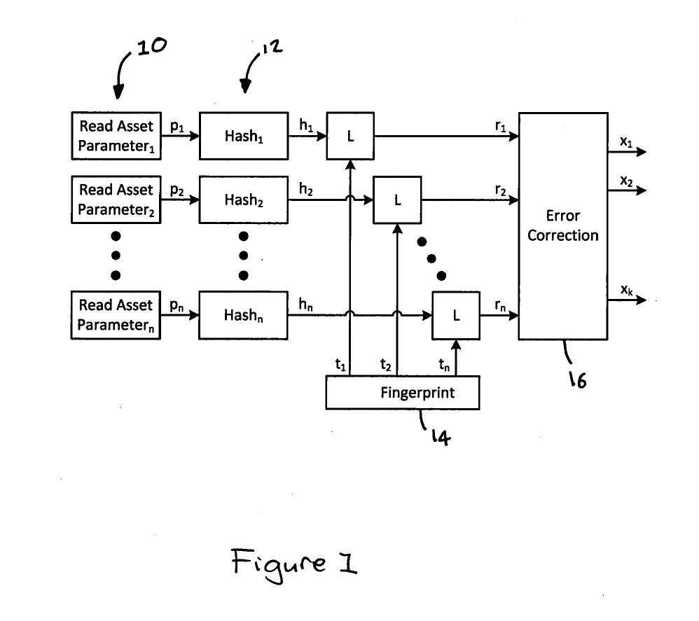

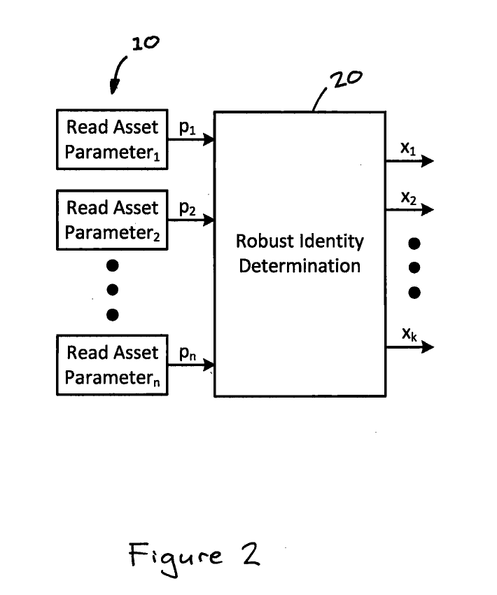

### DETAILED DESCRIPTION OF EMBODIMENTS OF THE INVENTION

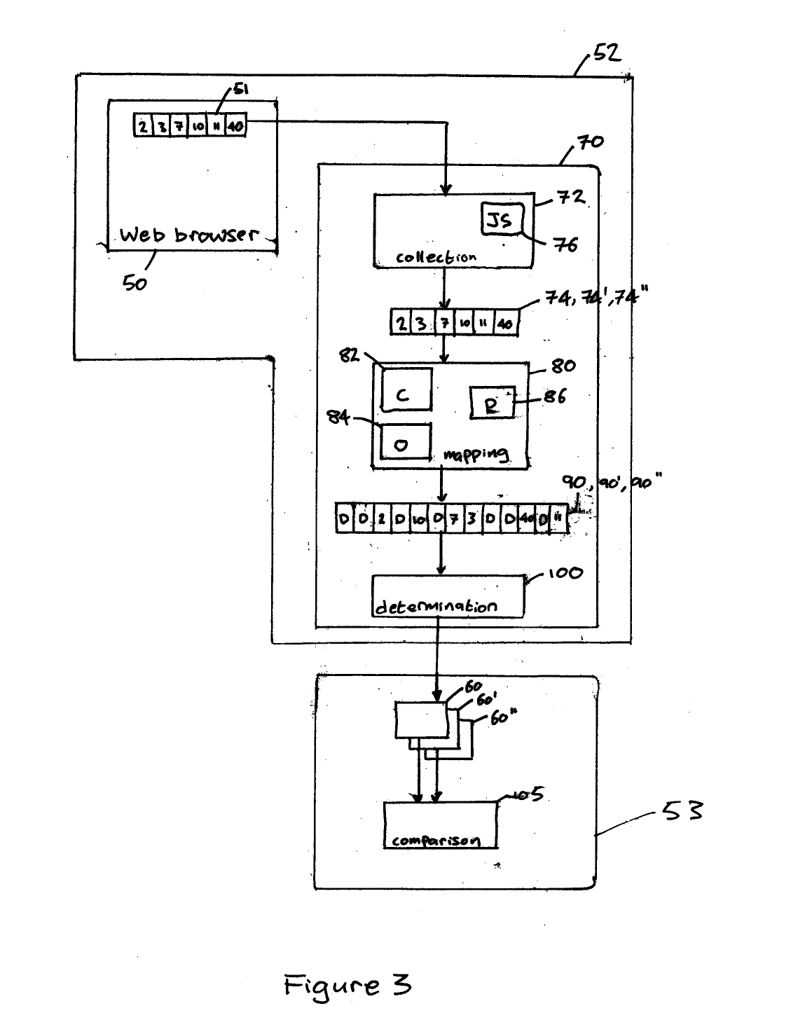

Referring now to FIG. 3, there is shown a web browser 50 installed on a computer device 52. The web browser has associated with it a plurality of web browser parameters 51 or properties of the web browser. Example web browser parameters are discussed in the article “How Unique Is Your Web Browser?” by Peter Eckersley of the Electronic Frontier Foundation, which was presented at the Proceedings of Privacy Enhancing Technologies Symposium 2010, and may include parameters such as version numbers of plug-in modules and other software elements of and associated with the browser, identities of installed modules, graphical capabilities, aspects of installed fonts, browser capabilities and so forth. Such a parameter may relate to a single data item held by the browser, or may represent a combination and/or subset of such a data item or items.

FIG. 3 also shows a number of functional elements which work together to generate an identifier 60 of the installed web browser. In the arrangement of FIG. 3 these functional elements form part of a web application 70 which is also installed on the computer device 52 and is arranged to operate in conjunction with the web browser 50, but the functional elements could instead be installed in other ways on the computer device 52, or partly or entirely on one or more remote computer entities such as a remote server connected to the computer device 52 over a network (not shown). Note that the invention may be used to generate an identifier of the computer device 52 itself, or of some other software component installed on the computer device 62 such as a word processor, an update manager, a media player and/or manager, an operating system etc, and the collected parameters may therefore be parameters relating to any such software application and/or it's installation and/or configuration, and/or to the operating system or other aspects of the computer device itself.

The functional elements include a collection function 72 which is arranged to collect from the web browser at least some of the available parameters of the web browser. The collected parameters are shown as data structure 74. The collection of browser parameters can conveniently be done using JavaScript code 76 provided to the browser by the collection function 72 as part of a web page, assuming that the browser includes a JavaScript engine for the processing of such scripts and a suitable API to obtain various browser specific parameters. Other ways of collecting browser parameters will be apparent to the skilled person.

In many browsers the collection of some browser parameters can be carried out using JavaScript code along the following lines:

```
var np = navigator.plugins;
for (var i = 0; i < np.length; i++) {
  plist[i] = np[i].name;
  plist[i] += np[i].description + “; ”;
  plist[i] += np[i].filename + “;”;
  for (var n = 0; n < np[i].length; n++) {
    plist[i] += “ (“ + np[i][n].description +”; “+ np[i][n].type +”;
      “+ np[i][n].suffixes + ”)”;
  }
  plist[i] += “. ”;
}
```

The above script uses the standard JavaScript API “navigator.plugins” to obtain a reference to a data structure with details about the currently installed browser plug-in modules. The remaining code converts that into an identifying string for each plug-in. There are thousands of browser plug-in modules, but a single instance of an installed web browser 50 typically will not usually have more than about 30 different plug-in modules installed

Similar scripts can be used to collect other browser parameters using available JavaScript API's possibly in combination with CSS constructs. With these additional sources, the range of potential parameters increases dramatically.

Note that in any particular installed web browser 50 only a small subset of potential browser parameters will be present, and that the particular combination of parameters present will typically vary widely even between the same browser type (for example Apple Safari, Google Chrome) on comparable platforms (for example Apple iphone, Microsoft Windows 7 PC), with extensive further variation being found in the actual values of the parameters. The parameters collected at any particular time by the collection function 72 will therefore be a sparse subset of the potential parameters which might in general be collected from the installed web browser, and both the parameters which are available from the web browser 50 and their values will vary over time, for example as plug-in modules are updated, added and deleted, as the font set changes, or as the resolution of the graphical display is changed.

The functional elements also include a mapping function 80 which receives the collected parameters 74 from the collection function 72, and processes them to generate a permuted extended parameter set 90. The mapping function 80 may include a number of different functions, which may operate in various different orders or simultaneously on the collected parameters 74. One such function is a compression function 82, which is arranged to compress some or all of the parameters collected from the web browser for example using hashing functions, an XOR operation on the characters in a parameter string, and or other suitable data reduction processes, which may typically vary depend on the nature of a parameter being processed or compressed. Such compression preferably aims to preserve the entropy found in the potential range of values of a particular collected parameter. The compression function may also combine various collected parameters or parts of collected parameters received from the web browser 50 to form other, composite versions of the collected parameters.

The collected parameters 74 may not always be collected in the same order from one collection action of the collection function 72 to another, for example because of the way in which the web browser responds to requests from the collection function 72, and this is particularly likely to be the case when a parameter has been added or removed from the browser parameters 51. The mapping function 80 may therefore also sort the collected parameters (in compressed form if required) using a sorting scheme 84, to ensure consistency in ordering of the collected parameters between repeated operations of the collection and mapping functions. An example sorting scheme 84 could be an alphabetic sort on a list of string parameters.

The mapping function 80 generates the permuted extended set of parameters 90 by applying a permutation 86 to the collected parameters (in sorted and/or compressed forms as appropriate) in combination with a plurality of dummy parameters (denoted in the illustrated permuted extended set of parameters as “D”). The number of parameters in the combined set of collected parameters and dummy parameters to which the permutation is applied will typically be much lower than the potential number of different parameters which could be collected from the web browser, this potential number being closely related to the entropy of the collected parameters across a large population of web browsers. The Peter Eckersley paper referenced above reports typical entropy of collectable browser parameters of at least 18 bits. As most browser parameters have a fairly limited number of different values (say 8 bits of entropy), this suggests that Eckersley found around 210 different parameters to be collectable in practise over the population of browsers in his experiments. A typical installed web browser might contain a parameter set with approximately 50 different collectable parameters.

The total number of parameters in the combined set of collected parameters and dummy parameters to which the permutation is applied may be predetermined and used by the mapping function consistently between operations on different sets of collected parameters. For example, the total number of parameters to be permuted could be set at around two or three times the typical number of collected parameters, for example, such that the number of dummy parameters is always at least the same as the number of collected parameters.

The dummy parameters D may be allocated default values, for example all being allocated the same default value, for example a zero integer value, or different values such as random values.

The process of permutation of the extended parameter set, including the dummy parameters, may be carried out in various ways, before, after or in combination with the other processes carried out by the mapping function. The permutation 86 may be defined, for example, by a random permutation table or other structure which defines a reordering of the collected parameters in combination with the dummy parameters, in which the dummy parameters will typically be interspersed among the collected parameters (and vice versa). The permutation 86 is maintained without change by the mapping function 80 for operation on multiple different sets of collected parameters over a period of time so that the permuted extended parameter sets 90, 90′, 90″ generated from corresponding sets of collected parameters 74, 74′, 74″ can be used to generate multiple versions of the identifier 60, 60′, 60″ of the browser.

The permutation 86 could be generated locally in the web app 70 or otherwise at the device 52, or could be communicated to the device from a remote server. The permutation is preferably stored in an obfuscated form. Without knowledge of the permutation 86 it is hard for an attacker to derive information about the original parameters 51 or collected parameters 74 from the permuted extended parameter set 90, which helps preserve confidentiality.

The permuted extended parameter set 90 is passed to a determination function 100 which is arranged to determine an identifier 60 of the web browser 50 from the permuted extended parameter set. The collection function, mapping function and determination function may repeat their operations at multiple different times to determine the identifier 60, 60′, 60″ at those times. In FIG. 3 the determined identifier is shown as being passed out of the computer device 52 to a remote entity 53, for example over a data network to a remote server. If multiple versions of the identifier 60, 60′, 60″ are generated at multiple times then these can be used by the remote entity in various ways, for example to determine that the identity of the browser remains unchanged, or to gain or provide to the computer device continued access to particular data or resources. Of course, such comparison or similar use of identifier or multiple versions of the identifier could also or instead take place within the web app 70 or otherwise at the computer device 52 itself.

In many applications, the generated identifier 60. 60′, 60″ will typically not be stored for extended periods at the computer device 52 itself, to reduce the risk of compromise or attack.

To generate identical identifiers at different times, using collected parameters which are expected to change in both presence within the collected parameters 74 and in value between those times, the determination function 100 preferably implements a robust identity determination based on the permuted extended parameter set 90. Some suitable robust identity determination schemes are taught in WO2012/122621 and WO2012/122674, and can be applied using the permuted extended parameter set 90. The permuted extended parameter set is well suited as input to such schemes and algorithms because it has a fixed number of elements, unlike the parameters collected from the web browser by the collection function 70 which will vary in the number of parameters from time to time. The use of the permuted extended parameter set therefore reduces the propagation of changes in the collected parameters to the identifier 60, allowing the use of a simpler error correction scheme in the determination function 100. The propogation of changes is reduced because replacing or adding an element to the collected parameters does not shift all parameters, but only a subset, and these changes are distributed over the entire permuted extended parameter set.

The teaching of WO2012/122621 can be applied by generating a share corresponding to each parameter of the permuted extended parameter set, applying a secret sharing algorithm to a number of subsets of the plurality of shares to derive a plurality of candidate identifiers, the number of subsets being determined in accordance with a tolerance threshold for differences in the parameters of the permuted extended parameter set as compared to previous or original values of the permuted extended parameter set, and determining a most prevalent of the candidate identifier values as a final identifier of the web browser 50. The secret sharing algorithm could be a (M−k,N)-secret sharing algorithm, where N is the number of the plurality of shares, M<N, and k is a predetermined constant. Other details are provided in WO2012/122621 which is hereby incorporated by reference for this and all other purposes.

The teaching of WO2012/122674 can be applied by processing a permuted extended parameter set and a fingerprint in accordance with a pre-determined function to obtain code symbols, the fingerprint being associated with the web-browser and being based on an earlier permuted extended parameter set from the mapping function 80. In this way the permuted extended parameter set is transformed into an error correcting code. An error correction algorithm is then applied to the code symbols to obtain the identifier 60. The error correction algorithm could be a Reed-Solomon error correcting code or similar. Other details are provided in WO2012/122674 which is hereby incorporated by reference for this and all other purposes.

The determination function 100 may require initialisation in order to acquire suitable lookup information to transform the permuted extended parameter set into an identifier 60 which is suitably robust to changes in the collected parameters. This may involve sending an earlier generated permuted extended parameter set or set of collected parameters to a remote server which calculates suitable configuration data for use at the computer device, and in particular error correcting data to ensure that the correct identifier can be calculated. For example, suitable error correcting code may be provided by such a server, which may also be a server that provides the web application code to the computer device. Calculation of the error correcting code at the web application will frequently be undesirable because of the increased potential for attacks. To this end, an anonimised version of the collected parameters or permuted extended parameter set (for example using parameters initially collected) may be sent from the computer device to the server which then returns error correcting code capabilities in the form of configuration data. The server then also knows the value of the identifier 60 that the computer device will generate and use in subsequent internal calculations and/or communication protocols.

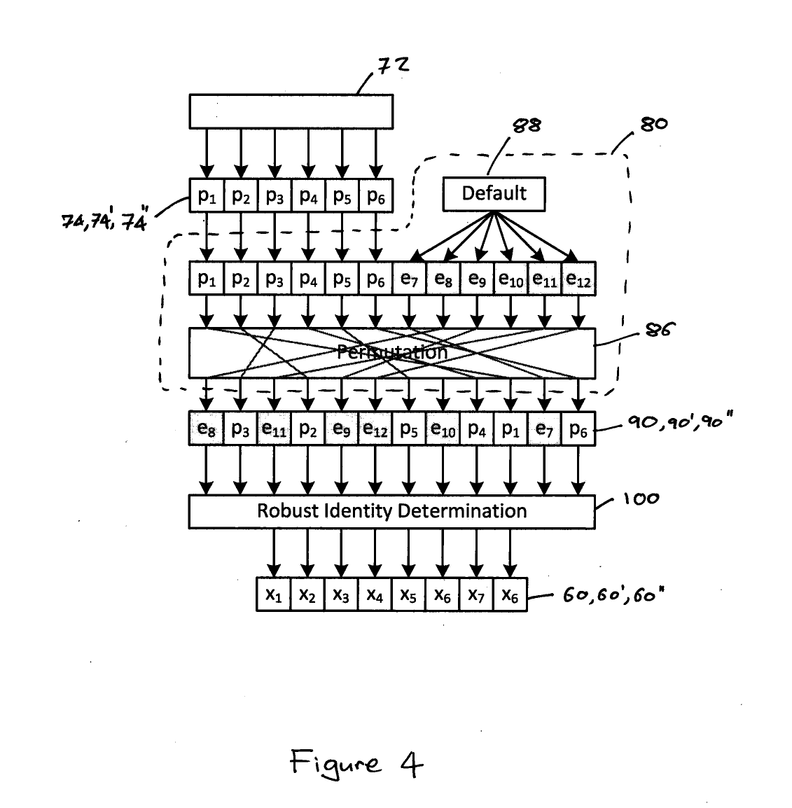

FIG. 4 summarises the processes carried out by the mapping function 80 in combination with the collection function 72 and the determination function 100. The collection function 72 obtains parameters 74 (p₁ . . . p₆) of the web browser, for example using JavaScript elements 76. The mapping function 80 adds to the set of collected parameters a number of dummy parameters (e₇ . . . e₁₂) each having a default, random or other value 88. The mapping function 80 applies a permutation 86 to the collected parameters and dummy parameters D to output a permuted extended parameter set 90. The mapping function may also carry out compression and ordering of the collected parameters 74 (or some or all of such processes could take place in the collection function 72). Finally, the determination function 100 processes the permuted extended parameter set to yield an identifier 60 of the web browser. The whole process may be repeated at different times, represented by multiple sets of collected parameters 74, 74′, 74″, multiple corresponding permuted extended parameter sets 90, 90′, 90″, and multiple identifiers 60, 60′, 60″, for example to provide an indication that the identity of the web browser has remained the same or has changed between repeated processes, for example by concluding that the identity has changed if the identifier 60, 60′, 60″ has changed. Repeated calculations of the identifier may similarly be used to gain continued access to resources from a remote entity 53 and for other purposes.

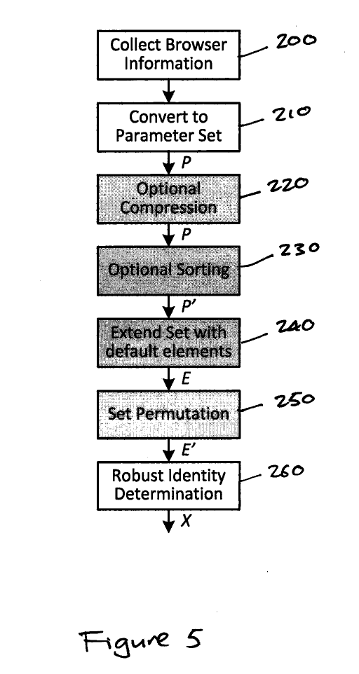

The flow chart of FIG. 5 illustrates the above embodiments of the invention as a series of steps. These steps may enable a resident web app 70 to generate an identifier 60 denoted as X, using a script 76. Browser parameters 51 are collected 200 and converted 210 into a parameter set P (denoted as 74 in earlier figures) of variable size (e.g. an array of strings). The parameter set elements may be compressed 220 using one or more hashing functions or other suitable data reduction processes. In order to obtain the same ordering of collected parameters P from one collection to the next, an optional sorting step 230 orders the collected parameter set. The ordered collected parameter set P′ is then extended 240 with dummy elements producing an extended parameter set E with a fixed number of elements between repeats of the series of steps at different times. The extended (ordered) parameter set is then permuted 250 generating a permuted extended parameter set E′. The set permutation step 250 can advantageously use a web app specific permutation table which allows two installed web browsers with the same configuration to generate a different permuted extended set E′. An example is a locally initialised permutation table using a (pseudo) random number generator. Without knowledge of the permutation table, it is hard for a third party to derive the parameter set P from the permuted extended set E′. This helps in protecting the confidentiality of the browser parameter set.

The permuted extended parameter set E′ forms the input to the robust identity determination step 260 that has the ability to correct for changes in the collected parameters which result from changes to the web browser configuration. The above mentioned WO2012/122621 and WO2012/122674 publications describe ways to implement such a step.

Note that the order of the steps in FIG. 5 prior to the set permutation step 250 may be varied without any change to the result of the process.

It will be understood that variations and modifications may be made to the described embodiments without departing from the scope of the invention as defined in the appended claims. For example, it is to be understood that any feature described in relation to any one embodiment may be used alone, or in combination with other features described in respect of that or other embodiments.

1. A method of generating an identifier of a computer device, comprising:
collecting a plurality of parameters of the computer device;
forming a permuted extended set of parameters comprising applying a permutation to the collected parameters in combination with a plurality of dummy parameters;
generating the identifier of the computer device from the permuted extended set of parameters.

2. A method comprising repeating the steps of claim 1 at a plurality of different times with the same permutation to determine the identifier of the computer device at each of the plurality of different times.

3. The method of claim 2 further comprising using the identifier determined at each of the plurality of different times to confirm that the identity of the computer device is unchanged between the different times.

4. The method of claim 3 wherein the set of parameters of the plurality of collected parameters changes, irrespective of the values of those parameters, between at least two of the different times.

5. The method of claim 3 wherein at least one value of a parameter changes between at least two of the different times.

6. The method of claim 2 wherein the combined number of collected parameters and dummy parameters used to form the permuted extended set is the same at each of the plurality of different times.

7. The method of claim 1 wherein the number of dummy parameters is at least as many as the number of collected parameters in the permuted extended parameter set.

8. The method of claim 1 further comprising compressing at least some of the collected parameters included in the permuted extended parameter set, relative to the those parameters as collected from the computer device.

9. The method of claim 1 further comprising ordering the collected parameters according to an ordering scheme such that the order of collected parameters in the permuted extended parameter set is unchanged between each of the plurality of times, irrespective of whether one or more of the collected parameters are deleted or added between any of the plurality of times.

10. The method of claim 1 wherein determining the identifier of the computer device from the permuted extended set of parameters comprises transforming the permuted extended set of parameters into an error correcting code.

11. The method of claim 10 wherein the error correcting code is a Reed Solomon code.

12. The method of claim 1 wherein the parameters of the computer device are parameters related to a software application installed on the computer device, and the generated identifier of the computer device is an identifier of the installed software application.

13. The method of claim 12 wherein the installed software application is a web browser.

14. Apparatus for determining an identifier of a computer device, the apparatus comprising:
a collection function arranged to collect a plurality of parameters of the computer device;
a mapping function arranged to form a permuted extended set of parameters comprising applying a permutation to the collected parameters in combination with a plurality of dummy parameters;
a determination function arranged to determine an identifier of the computer device from the permuted extended set of parameters.

15. The apparatus of claim 14 further comprising a compression function arranged such that the collected parameters in the permuted set of parameters are compressed relative to the parameters as originally collected.

16. The apparatus of claim 14 further comprising an ordering function arranged such that the order of collected parameters in the permuted extended set is ordered according to an ordering scheme.

17. The apparatus of claim 14 further comprising a comparison function arranged to compare identifiers determined by the determination function based on parameters collected from the web browser at a plurality of different times, and to confirm therefrom that the identity of the computer device is unchanged between the different times.

18. The apparatus of claim 17 wherein the apparatus is arranged such that the determination function may determine the same identifier of the computer device even if the set of parameters of the plurality of collected parameters changes, irrespective of the values of those parameters.

19. The apparatus of claim 17 wherein the apparatus is arranged such that the determination function may determine the same identifier of the computer device even if at least one value of a parameter changes.

20. The apparatus of claim 17 wherein the combined number of collected parameters and dummy parameters used to form the permuted extended set is the same at each of the plurality of different times.

21. The apparatus of claim 17 wherein the number of dummy parameters is at least as many as the number of collected parameters.

22. The apparatus of claim 14 wherein the collection function is arranged to collect parameters related to a software application installed on the computer device, and the identifier of the computer device is also an identifier of the installed software application.

23. The apparatus of claim 22 wherein the software application is a web browser.

24. The apparatus of claim 23 wherein the collection function is arranged to provide executable code to the web browser to cause the web browser to return the collected parameters to the collection function.

25. A system comprising: the apparatus of claim 14; and the computer device having the software application installed thereon.

26. The system of claim 25 wherein the apparatus is also installed on the computer device.

27. The system of claim 26 wherein the software application is a web browser, the system comprises a web application installed on the computer device for execution in conjunction with the web browser, and at least the mapping function is comprised within the web application.

28. A non-transitory computer readable medium comprising computer program code which, when executed by one or more processors, causes the one or more processors to carry out a method of generating an identifier of a computer device, the method comprising:
collecting a plurality of parameters of the computer device;
forming a permuted extended set of parameters comprising applying a permutation to the collected parameters in combination with a plurality of dummy parameters;
generating the identifier of the computer device from the permuted extended set of parameters.
